(19) United States
(12) Patent Application Publication
(10) Pub. No.: US 2009/0268101 A1
(43) Pub. Date: Oct. 29, 2009

(54) Direct conversion television receiver

(76) Inventors: Parveen Shukla, Meadows (GB); Bernard Arambepola, Enfield (GB); Thushara Hewavithana, Borehamwood (GB); Nick Cowley, Wroughton (GB)

Correspondence Address: TROP, PRUNER & HU, P.C., 1616 S. VOSS RD., SUITE 750, HOUSTON, TX, 77057-2631, US

(21) Appl. No.: 12/150,006

(22) Filed: Apr. 24, 2008

(51) Int. Cl. H04N 5/44; H04B 1/10

(52) U.S. Cl. 348/729; 455/311; 348/E05.096

(57) ABSTRACT

A direct conversion television receiver may include a phase de-rotator which substantially undoes the phase rotation of a phase rotator. The phase de-rotator takes the low pass filtered signal and substantially removes the rotation caused by the phase rotator. As a result, it is easier to estimate the phase and gain imbalance and to make a correction for the phase and gain imbalance, via a feedback loop, without the effects of phase rotation.

### BACKGROUND

This relates generally to direct conversion television receivers.

In a direct conversion television receiver, the radio frequency signal is directly converted to baseband without going through an intermediate frequency stage. Such direct conversion receivers use so-called zero-IF tuners.

The conversion to baseband may be carried out by mixing the input with in-phase (I) and quadrature (Q) local oscillator signals. This conversion usually results in phase and gain imbalance that is corrected in the digital domain using a digital demodulator.

### BRIEF DESCRIPTION OF THE DRAWINGS

FIG. 1 is a schematic depiction of one embodiment of the present invention.

### DETAILED DESCRIPTION

The in-phase (I) and quadrature (Q) components in a direct conversion receiver must be balanced in phase and gain because otherwise IQ crosstalk would give rise to significant performance loss. In order to balance the phase and gain, initially there must be a measurement of the imbalance and then a correction for the imbalance.

The measurement is done after the I and Q channels have passed through a baseband low-pass filter. This is because digital communication receivers and, in particular, television receivers, work in the presence of very high power adjacent channels. For example, a receiver may be tuned to a weak signal from a distant station, or there could be very high power signals from nearby transmitters in adjacent channels. The undesired signals are filtered out before any demodulation is done and before any IQ imbalance measurement of the unwanted channel is implemented.

In some cases, there may be input frequency offsets. The desired channel may not be centered at zero frequency for a number of reasons. There may be a frequency step inherent with the tuner that prevents tuning to the exact frequency. There could also be an error in the tuner frequency reference or crystal. Television channels also can be transmitted with deliberate frequency offsets. The tuner can also introduce a deliberate frequency offset. These frequency offsets can be provided to a demodulator or estimated in the demodulator and an automatic frequency correction (AFC) loop may be applied to correct for such offsets.

In accordance with some embodiments of the present invention, the IQ imbalance measurement is done after low pass filtering the wanted channel. To filter the desired channel, it may first be brought to true baseband. The process of bringing the channel to baseband is one of complex multiplication, that mixes the I and Q channels. In order to take account of this mixing, a complex multiplier (producing a phase de-rotation) may be utilized to approximately undo the effect of the earlier complex multiplication (which produced a phase rotation) for the sample that is used for phase and gain imbalance estimation.

In some embodiments (like this one), separate filtering arrangements for IQ imbalance measurements may not be necessary and filters already present in the main data path, such as digital base-band filters, can be used for this purpose.

The frequency of the crystal reference may change while the system is heating up. During this heating up time, the tuner frequency offset may be changing and this change may be tracked using a digital mixer/AFC arrangement, as described above.

In some embodiments, the system continually removes IQ imbalances over time while the system is in operation.

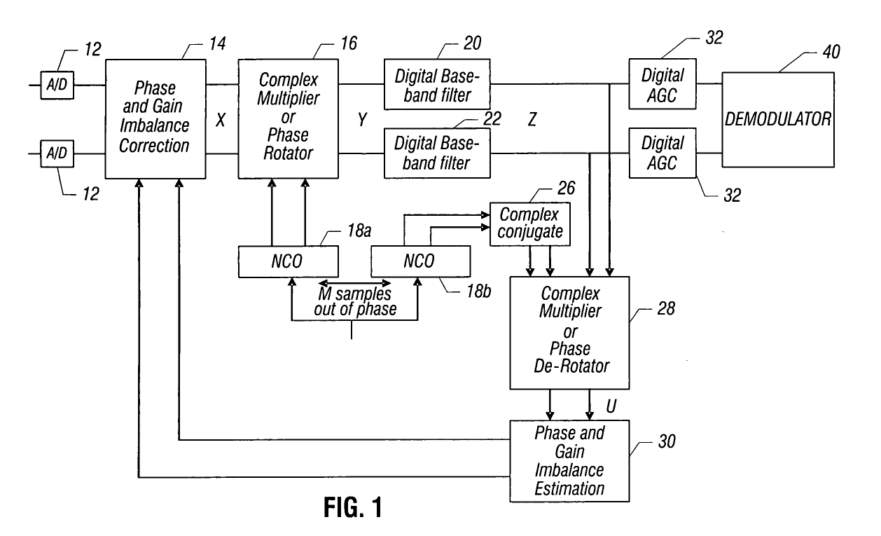

Referring to FIG. 1, a set of analog to digital (A-D) converters 12 provide input signals to a phase and gain imbalance correction circuit 14 that implements the phase and gain and imbalance correction using latest estimates for phase and gain imbalance (these estimates may be zero at first use of the system) The signals are then complex multiplied (i.e. phase rotated), and low pass filtered. When the phase and gain imbalance estimates are zero (which may be the case at first use of the system) the I and Q signals at the input to the phase rotator 16 are uncorrected. The I and Q signals are provided to the complex multiplier or phase rotator 16, which implements conventional phase rotation involving multiplication and addition. As a result, the I and Q signals are mixed. Then, the I and Q signals are baseband filtered in a pair of digital baseband filters 20, 22 and provided to the automatic gain control (AGC) units 32 before being provided to a demodulator 40.

A feedback loop provides the IQ imbalance measurement required for correction. Samples from the outputs of the baseband filters 20 and 22 are subjected to a complex multiplier or phase de-rotator 28 which approximately undoes the effect of the complex multiplier or phase rotator 16 with respect to the feedback loop signals. Then, the phase and gain imbalance is estimated at block 30 and the estimate is used for phase and gain imbalance correction in block 14.

A pair of numerically controlled oscillators (NCOs) 18a and 18b may be utilized to produce two oscillator signals that are M samples out of phase and to provide a signal to a complex conjugate unit 26 for use in the de-rotator 28. One NCO 18a may be coupled to the phase rotator 16 and the other NCO 18b may be coupled to the phase de-rotator 28 after complex conjugation by unit 26.

In other embodiments only one NCO can be used, i.e. unit 18a present and unit 18b removed, with the input to complex-conjugate unit 26 provided by the output of NCO unit 18a delayed by M samples (implies use of delay line).

In order to design the system, initially, a group delay of the baseband digital low pass filter 20, 22 is determined. In the case of a symmetric finite impulse response (FIR) filter of length N, the group delay is equal to N/2. In one embodiment, a digital elliptic recursive filter is used to save hardware. In such a system, the group delay is not a constant, but an approximate value may be estimated in the passband of the filter. This can then be converted to sample intervals.

If the group delay in the sample periods is M, the complex exponential that is used for phase de-rotation is delayed by M samples. This delayed exponential is used to de-rotate the signal before phase and gain imbalance estimation in the de-rotator 28. In practice, M can be quite large and, hence, a delay can be expensive in hardware. Instead, a second NCO 18b may be utilized that is lagging the first NCO 18a by M samples to create the second sequence required for de-rotation.

If it is assumed that the filter implements a unitary transformation, its output is then equal to its input, but with an M sample delay which is the group delay of the filter. Then, the complex signals X, Y, Z, and U, in FIG. 1, are as follows:

Y(i)=X(i)exp(j2π Δf i)

Z(i)=Y(i−M)

U(i)=Z(i)exp(j2π Δf(M−i))=X(i−M)

As a result, the phase rotator and phase de-rotator functions cancel out exactly. Then the phase and gain imbalance estimator 30 is working out the phase and gain imbalance using inputs with effectively no phase rotation. However, a filter with unitary transformation is used only for illustration.

When a proper low pass filter is used, the de-rotation is not able to exactly remove the phase rotation at the input. In the case of a finite impulse response filter, the filter multiplies and adds N successive samples in a delay line. These N samples will have different phase rotations. Therefore, it is not possible to remove the phase rotation introduced at the input of the filters by a single phase rotation at its output:

$$\begin{matrix}Z ( k ) = {\sum }_{i = 0}^{N - 1} h ( i ) Y ( k - i ) \\ = {\sum }_{i = 0}^{N - 1} h ( i ) X ( k - i ) exp ( j2πΔ f ( k - i ) )\end{matrix}$$

$$\begin{matrix}U ( k ) = Z ( k ) exp ( - j2πΔ f ( k - M ) ) \\ = {\sum }_{i = 0}^{N - 1} h ( i ) exp ( j2πΔ f ( M - i ) ) X ( k - i )\end{matrix}$$

An exact cancellation only results when all of the components are zero except for the central component h(M). Therefore, in the presence of a filter, this phase de-rotation does not automatically cancel out all of the phase rotation at the input. For example, if the actual filter is an eighth order digital elliptic filter, the de-rotator will not mathematically cancel out the effect of the phase rotation.

Although the complete signal is not totally canceling, if one considers the useful signal in the passband of the low pass filters, for which the group delay is approximately constant, the de-rotator does cancel out the rotation introduced by the phase rotator. For the signal within the passband, the filter acts as a unitary transformation with delay M and, therefore, when the transformation is unitary, the de-rotator clearly cancels out the effect of the rotation. Even if this is not a perfect cancellation, this is still sufficient to implement the correction via a feedback closed loop system.

In some embodiments, the two NCOs 18a and 18b run M samples out of phase. The second NCO 18b samples are triggered after the samples to the first NCO 18a.

The phase and gain imbalances affect the I and Q channels, giving the signals I⁽¹⁾ and Q⁽¹⁾, as described in the following equations:

I⁽¹⁾=(1+ε)I

Q⁽¹⁾=(1−ε)(Q cos(φ)+I sin(φ))

where ε, φ represent the gain and phase imbalance respectively. These can be estimated from time averages of I⁽¹⁾ and Q⁽¹⁾ as:

$$K = \frac{( 1 + ɛ )}{( 1 - ɛ )} = \sqrt{\frac{mean ( {I}^{( 1 )} {I}^{( 1 )} )}{mean ( {Q}^{( 1 )} {Q}^{( 1 )} )}}$$

$$sin ( ϕ ) = \frac{( 1 + ɛ )}{( 1 - ɛ )} \frac{mean ( {I}^{( 1 )} {Q}^{( 1 )} )}{mean ( {I}^{( 1 )} {I}^{( 1 )} )} = K \frac{ mean ( {I}^{( 1 )} {Q}^{( 1 )} )}{mean ( {I}^{( 1 )} {I}^{( 1 )} )}$$

Hence the measurement procedure includes the following steps:

a) Work out the mean power in each of the I and the Q channels over a long period;

b) Work out the mean of the IQ product over a long period;

c) Work out the ratios of the two mean power levels to give K; and

d) Then from this and the mean value of the IQ product work out sin(φ).

The gain imbalance may be corrected by multiplying the Q path by K:

I⁽²⁾=I⁽¹⁾

Q⁽²⁾=Q⁽¹⁾ K

Then the phase imbalance may be corrected using the following equations.

I⁽³⁾=I⁽²⁾−I⁽²⁾ sin²(φ)

Q⁽³⁾=Q⁽²⁾−I⁽²⁾ sin(φ)

Since the phase and gain imbalance correction is applied in a feedback loop, the measurements are actually applied on I⁽³⁾ and Q⁽³⁾ after phase rotation, digital filtering and phase de-rotation.

The feedback loop may work in three stages: acquisition, transition, and tracking. Typical parameters used in our current design are as follows.

In acquisition, the digital AGC estimates the gain required to keep the signal level at the desired value every 0.05 ms. This AGC gain may be applied to both the I and Q channels. The gain imbalance may be estimated over averaging periods of approx. 0.4 ms, and correction is applied every time a new estimate is calculated (to the Q channel only) in one embodiment. No phase imbalance may be estimated or corrected for at this stage. When the AGC has locked, the transition stage is entered. By now the gain imbalance estimate is very close to steady-state.

In transition, the AGC gain may be estimated every 3 ms, and the gain imbalance every 25 ms. This keeps the variation in the signal level very small, which is required for highly mobile environments. At this point the phase imbalance estimation is started, with time averaging periods of approximately 6 ms. When two such estimates have been made and corrections applied, the tracking stage is entered.

In tracking, the phase estimation time averaging interval is increased to around 25 ms. In some embodiments, the results are as follows in a digital video broadcasting terrestrial (DVB-T) television receiver (European Telecommunications Standards Institute (ETSI, Sophia-Antipolis Cedex France) standard EN300 744 V1.5.1 Digital Video Broadcasting).

| | | |
|---|---|---|
| Frequency offset: | 200 | kHz |
| DVB-T Channel bandwidth: | 8 | MHz |
| Sampling rate: | 20 | MHz |
| Phase imbalance: | 5 | degrees |
| Gain imbalance: | 2 | dB |

These results show that the phase imbalance is reduced to less than 0.5 degree within about 20 ms. This time may be put into context with typical acquisition times of orthogonal frequency division multiplexing (OFDM) based digital television. An 8K OFDM symbol is about 1 ms and typically about 100 symbols are required to acquire an OFDM television channel. Hence, the acquisition periods given above are very small compared to OFDM channel acquisition times. Furthermore, phase and gain imbalance correction can happen in parallel with OFDM timing and frequency acquisition and hence may not add to the overall acquisition time. In practice, one may wait for the measured imbalance to go below about 2 degrees before starting OFDM acquisition.

The architecture for correcting for phase and gain imbalance in direct conversion receivers works in the presence of frequency offsets and strong adjacent channels in some embodiments.

Application of the phase de-rotator before phase and gain and phase imbalance estimation does not necessarily mathematically cancel out the phase rotation introduced by the “conversion to true baseband” digital mixer because of the digital (elliptic) filter that exists between the phase rotator and the de-rotator. However, it does cancel out the rotation for the wanted part of the signal that resides within the bandwidth of digital filter. In fact, this wanted part of the signal could well be several decibels below the total signal power in the presence of strong adjacent channels. Without this de-rotation the I and Q samples get mixed-up by the mixer and hence does not allow an estimation of the imbalance.

The phase and gain correction is applied in the form of a feedback loop with a fast acquisition state and a relatively slow tracking phase. Without allowing for the group delay of the filter between rotation and de-rotation, the system may fail to work and the feedback loop may become unstable.

The outputs from the filters 20, 22 may pass through digital automatic gain control circuits 32 to a demodulator 40. The demodulator 40, in one embodiment, may be an OFDM demodulator of a DVB-T television receiver.

References throughout this specification to “one embodiment” or “an embodiment” mean that a particular feature, structure, or characteristic described in connection with the embodiment is included in at least one implementation encompassed within the present invention. Thus, appearances of the phrase “one embodiment” or “in an embodiment” are not necessarily referring to the same embodiment. Furthermore, the particular features, structures, or characteristics may be instituted in other suitable forms other than the particular embodiment illustrated and all such forms may be encompassed within the claims of the present application.

While the present invention has been described with respect to a limited number of embodiments, those skilled in the art will appreciate numerous modifications and variations therefrom. It is intended that the appended claims cover all such modifications and variations as fall within the true spirit and scope of this present invention.

What is claimed is:

1. A method comprising:
phase rotating an input signal in a direct conversion receiver;
low pass filtering the phase rotated signal;
phase de-rotating the filtered, rotated signal;
estimating the phase and gain imbalance;
using the estimate for phase and gain imbalance correction;
applying the phase and gain imbalance correction at the point before the phase rotation of the input, via a feedback loop.

2. The method of claim 1 including providing a pair of oscillators, one oscillator used for rotating the input signal and the other oscillator used for de-rotating the input signal.

3. The method of claim 2 including providing out of phase signals to said oscillators.

4. The method of claim 3 wherein causing the oscillator used for de-rotation to lag the oscillator used for phase rotation.

5. The method of claim 4 including causing the oscillator used for de-rotation to lag by amount equal to a group delay.

6. The method of claim 5 including coupling an oscillator output to a complex conjugate unit and coupling the complex conjugate unit to a device for phase de-rotation.

7. The method of claim 1 including approximately canceling the phase rotation by phase de-rotation.

8. The method of claim 7 including substantially canceling the phase rotation for a portion of the signal within a low pass filtering passband.

9. A direct conversion television receiver comprising:
a phase rotator;
a low pass filter coupled to said phase rotator;
a phase de-rotator coupled to said low pass filter; and
a phase and gain imbalance correction unit coupled to said phase de-rotator.

10. The receiver of claim 9 including a pair of oscillators, the first oscillator coupled to said phase rotator and the second oscillator coupled to said phase de-rotator.

11. The receiver of claim 10 including a complex conjugate unit coupled to said second oscillator between said second oscillator and said phase de-rotator.

12. The receiver of claim 11 wherein said second oscillator lags the first oscillator.

13. The receiver of claim 12 wherein the second oscillator lags the first oscillator by an amount equal to a group delay.

14. The receiver of claim 9 wherein the phase de-rotator approximately cancels the rotation caused by said phase rotator.

15. The receiver of claim 14 wherein said phase de-rotator substantially cancels the phase rotation by said phase rotator for a portion of a signal within the passband of said low pass filter.
